(19) United States
(12) Patent Application Publication
(10) Pub. No.: US 2008/0288768 A1
(43) Pub. Date: Nov. 20, 2008

(54) Arrangement and method for reprogramming control devices

(75) Inventors: Peter Barowski, Rodgau (DE); Herbert Thomas, Dieburg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens Aktiengesellschaft

(21) Appl. No.: 11/799,691

(22) Filed: May 2, 2007

(30) Foreign Application Priority Data
May 3, 2006 (DE) 10 2006 020 562.6

(51) Int. Cl. G06F 9/00

(52) U.S. Cl. 713/100

(57) ABSTRACT

In an arrangement for reprogramming at least two control devices connected to one another via a data bus, each of the at least two control devices includes a reprogramming module for effecting reprogramming of the each of the at least two control devices with new program data according to a first reprogramming protocol. A conversion module connected to the data bus receives the new program data using a second reprogramming protocol, and transmits the new program data onto the data bus using the first reprogramming protocol.

### BACKGROUND OF THE INVENTION

1. Field of the Invention

The invention relates to an arrangement and a method for reprogramming at least two control devices connected to one another via a databus, wherein each of the at least two control devices contains a reprogramming module for carrying out the reprogramming of its own control device with new program data according to a first reprogramming protocol.

2. Description of the Related Art

Reprogramming a control device is generally also known by the term flashing. The software to be reprogrammed, which is to be reprogrammed by means of the new program data or to be overwritten by these, is stored in a nonvolatile rewritable memory chip, particularly a flash memory, in the control device. These memory chips are particularly distinguished by great ruggedness which is why they are preferably used compared with conventional memory media in control devices. A control device is understood to be an electronic device which, in addition to the memory chip, has at least one computing unit and a data input and a data output, the operation of a mechanized device, particularly of a motor vehicle, being influenced via the data output.

In general, current motor vehicles use a number of control devices which are connected to one another via a data bus, for example a CAN, LIN or MOST bus, for the purpose of mutual information exchange. From DE 102 11 426 A1, it is known to connect a reprogramming device to the data bus which transmits the new program data to at least one of the control devices via the data bus, for reprogramming the number of control devices. Reprogramming generally takes place in accordance with a reprogramming protocol in which the precise sequence of data communication between the control device and the reprogramming device during the reprogramming is specified. So that the control device also understands the reprogramming protocol, the control device contains a reprogramming module, also called flash loader. This module handles the data exchange with the reprogramming device and, after receiving the new program data, reprograms the memory chip in the control device.

The reprogramming protocol can be specified almost arbitrarily. Accordingly, various specifications of reprogramming protocols exist today on the market, particularly the motor vehicle market. The various protocols may define not only different commands but also different specific sequences of commands. In addition, a reprogramming protocol may contain protective mechanisms such as, for example, a data exchange for eliminating manipulations in which the reprogramming device authenticates itself to the control device, or a check of the authenticity of the new program data to be transmitted or a monitoring of the faultless and successful transmission of the new program data. The reprogramming protocol may additionally provides compression and/or encryption of the data to be transmitted.

The large variety of possible combinations of control devices and mechanized devices which are influenced by the control devices have led to a multiplicity of reprogramming protocols. Today, it is more and more prevalent that during the development, try-out and commissioning of mechanized devices, particularly of motor vehicles, both the manufacturer of the control devices and the manufacturers of higher-level functional groups and the final mechanized device manufacturer are involved in the software development. Since during the software development, simple and fast reprogramming of a control device used in the device is desired, its reprogramming module must accordingly be able to handle the different reprogramming protocols of the various manufacturers.

The development and maintenance effort required for this purpose from the manufacturers of the control device or of the reprogramming module is considerable.

### SUMMARY OF THE INVENTION

An object of the present invention to provide an arrangement and a method for reprogramming at least two control devices connected to one another via a data bus in which the effort for reprogramming the control devices is reduced over the prior art solutions.

The object of the present invention is met by an arrangement for reprogramming at least two control devices connected to one another by a data bus, including the at least two control devices, each having a reprogramming module configured to perform reprogramming according to a first reprogramming protocol, and a conversion module connected to the data bus, wherein new program data transmitted to the conversion module using a second reprogramming protocol are transmitted onto the data bus by the conversion module using the first reprogramming protocol.

The basic concept is here that only one uniform reprogramming protocol which is referred to as the first reprogramming protocol now applies to the at least two control devices connected to the data bus. The reprogramming modules present in each of the at least two control devices thus only need to be designed for managing the first reprogramming protocol which reduces the expenditure for providing the control devices in each case.

So that a manufacturer of a functional group or mechanized device at a higher level than the at least two control devices can still work with his own reprogramming protocol which will be called here the second reprogramming protocol, the conversion module is provided. The conversion module is connected to the data bus as a central translation unit and performs a conversion from the second reprogramming protocol into the first reprogramming protocol. For this purpose, the manufacturer connects his reprogramming device, which only needs to understand the second reprogramming protocol, either to the data bus or directly to the conversion module and initiates the reprogramming in the usual manner. In this context, the control devices can be addressed and reprogrammed either individually and independently of one another or in groups via the data bus.

In some cases, the reprogramming protocol does more than merely send out the new program data and provides a mutual data exchange between the respective control device and the reprogramming device. According to this particular embodiment, the conversion module places the data transmitted to it by the reprogramming device using the first reprogramming protocol onto the data bus using the second reprogramming protocol. The translation takes place here in both directions of data transmission.

In one embodiment of the present invention, the conversion module is a component of one of the at least two control devices. More specifically, the conversion module may be provided as software module in one of the at least two control devices. This dispenses with the requirement of a data bus node for the conversion module which reduces the costs of the arrangement.

In a further embodiment, the conversion module is capable of carrying out more than only one type of translation. That is, the conversion module also translates data, particularly of new program data, from a third programming protocol into the first reprogramming protocol and conversely. Naturally, extensions to four and more reprogramming protocols are similarly conceivable.

According to one application of this embodiment, the conversion module detects automatically whether the new program data are transmitted by the second reprogramming protocol or the third reprogramming protocol. As an alternative, the current valid reprogramming protocol which is to be translated into the first reprogramming protocol can also be input manually, for example via a hardware switch or a software flag. By comparison, automatic detection has the advantage, however, that there is no expenditure incurred during the conversion from one protocol variant to the next which becomes advantageously noticeable particularly with frequent changes between the development teams of the various manufacturers.

In one embodiment of the present invention, the new program data are transmitted to the conversion module through the data bus. This is an advantageous embodiment in the case of the buses in which the connection of a further subscriber in the form of the reprogramming device does not entail any further expenditure. In this case, the conversion module does not need to be connected to an additional communication interface in order to provide for communication to the reprogramming device which is independent of the data bus. In the remaining cases, the conversion module is connected to an additional communication interface in which case the new program data can be transmitted either in a wire-connected or wireless manner from the reprogramming device to the conversion module via the additional communication interface.

The object of the present invention is also met by a method for reprogramming at least two control devices connected to one another by a data bus, wherein each of the at least two control devices comprises a reprogramming module configured to perform reprogramming according to a first reprogramming protocol, wherein the method includes receiving, by a conversion module, new program data using a second reprogramming protocol, converting the new program data and placing the new program data on the data bus using the first reprogramming protocol.

The object of the present invention is also met by a conversion module which is configured to receive new program data using a second reprogramming and intended for reprogramming at least two control devices connected to each other by a data bus, the at least two control devices each including a reprogramming module configured to perform reprogramming using a first reprogramming protocol, the conversion module further configured to place the new program data onto the data bus using the first reprogramming module.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the text which follows, the invention will be explained in greater detail with reference to an exemplary embodiment and the drawing, in which:

FIG. 1 is a schematic diagram of an arrangement with an independent conversion module according to an embodiment of the present invention; and

FIG. 2 is a schematic diagram of an arrangement with an integrated conversion module according to another embodiment of the present invention.

### DETAILED DESCRIPTION OF THE PRESENTLY PREFERRED EMBODIMENTS

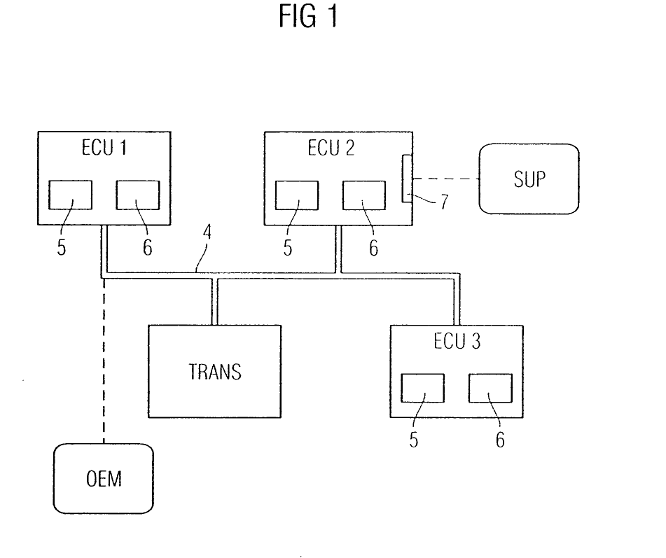

FIG. 1 shows an arrangement consisting of three control devices ECU1, ECU2, ECU3, a data bus 4 and a conversion module TRANS. The control devices ECU1 to ECU3 and the conversion module TRANS are connected to one another through the data bus 4. Each of the control devices ECU1 to ECU3 contains a memory unit 5 in which operating software of the associated control device and parameters for parameterizing the operating software are stored. In addition, each of the control devices ECU1 to ECU3 contains a reprogramming module 6 which can carry out reprogramming of the operating software and/or parameters located in the associated memory unit 5. Each of the reprogramming modules 6 is designed so that it understands and can process a first reprogramming protocol.

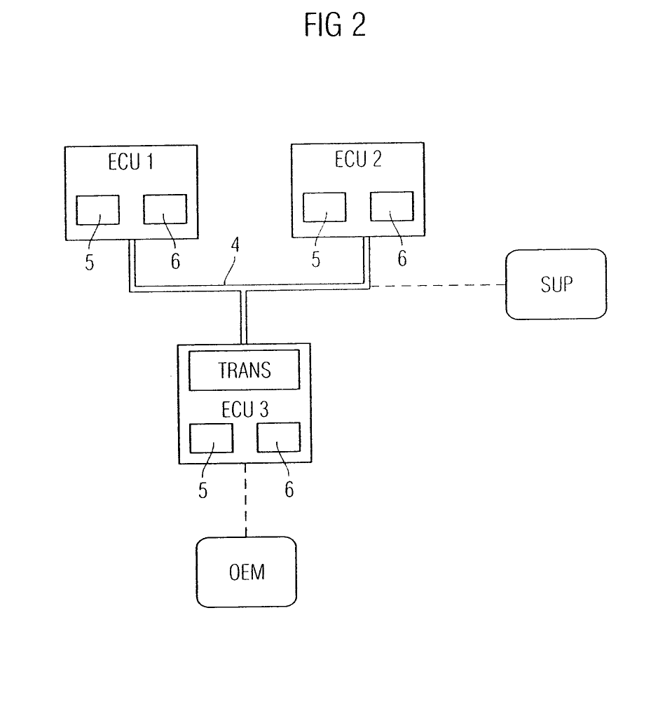

If one or more of the control devices ECU1 to ECU3 are to be reprogrammed by using a first reprogramming protocol, which is of interest, particularly, to the manufacturer of one or more of the control devices ECU1 to ECU3, a reprogramming device SUP is connected either directly to the data bus 4 (FIG. 2) or, as shown in FIG. 1, to one of the control devices ECU2 correspondingly provided with an interface 7. The interface 7 is preferably connected directly to the data bus 4.

During reprogramming by means of a second reprogramming protocol, a reprogramming device OEM is connected to the conversion module TRANS which carries out a translation of the reprogramming data from the second into the first reprogramming protocol and conversely and during this process places the data on the data bus 4 or fetches them from it.

In an embodiment according to FIG. 2, the conversion module TRANS is integrated in one of the control devices ECU3 which saves one of the bus nodes of FIG. 1. For reprogramming by means of the second reprogramming protocol, the reprogramming device OEM is connected to this one control device ECU3 which can be carried out in a wire-connected or wireless manner.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An arrangement for reprogramming control devices connected to a data bus, comprising:
a data bus;
at least two control devices connected to one another by the data bus, wherein each of the at least two control devices includes a reprogramming module configured for effecting reprogramming of the each of the at least two control devices with new program data in accordance with a first reprogramming protocol; and
a conversion module connected to the data bus and configured to receive new program data using a second reprogramming protocol and transmit the new program data onto the data bus using the first reprogramming protocol.

2. The arrangement of claim 1, wherein the conversion module is further configured to receive further data using the first reprogramming protocol and transmit the further data onto the data bus using the second reprogramming protocol.

3. The arrangement of claim 1, wherein the conversion module is a component of one of the at least two control devices.

4. The arrangement of claim 1, wherein the conversion module is further configured to receive the new program data using a third reprogramming protocol and transmit the new program data onto the data bus using the first reprogramming protocol.

5. The arrangement of claim 4, wherein the conversion module is configured to detect automatically whether the new program data are transmitted using the second preprogramming protocol or the third reprogramming protocol.

6. The arrangement of claim 1, wherein the conversion module receives the new program data from the data bus.

7. The arrangement of claim 1, wherein the arrangement is located in a motor vehicle.

8. A conversion module connectable to a data bus and configured to receive new program data using a second preprogramming protocol and transmit the new program data onto the data bus using a first reprogramming protocol, the new program data including data for reprogramming at least two control devices connected to one another by the data bus.

9. A method for reprogramming at least two control devices connected to one another by a data bus, wherein each of the at least two control devices includes a reprogramming module for effecting reprogramming of the each of the at least two control devices with new program data according to a first reprogramming protocol, the method comprising:
receiving new program data using a second preprogramming protocol;
converting the received new program data to produce converted new program data using the first reprogramming protocol; and
transmitting the converted new program data onto the data bus.
